(19) United States
(12) Patent Application Publication
(10) Pub. No.: US 2026/0037800 A1
(43) Pub. Date: Feb. 5, 2026

(54) Computer-Implemented Method and System for Training an AI-Based Prediction Model

(71) Applicant: Robert Bosch GmbH, Stuttgart (DE)

(72) Inventors: Faris Janjos, Stuttgart (DE); Juergen Mathes, Stuttgart-Moehringen (DE); Markus Mazzola, Tuebingen (DE); Martin Stoll, Renningen (DE); Maxim Dolgov, Renningen (DE)

(21) Appl. No.: 19/284,973

(22) Filed: Jul. 30, 2025

(30) Foreign Application Priority Data
Jul. 30, 2024 (DE) 10 2024 207 142.0

(51) Int. Cl. G06N 3/08

(52) U.S. Cl. CPC G06N 3/08

(57) ABSTRACT

A computer-implemented method is for training an artificial intelligence (AI) based prediction model for a given behavior planner that plans a future behavior of an at least partially automated self-driving vehicle based on aggregated scene-specific information. The prediction model is trained to predict a future development of a traffic scene based on aggregated scene-specific information. At least one training data set with training data elements generated from scene-specific information from training scenes is used for training. The behavior planner is used to determine a weighting for each training data element, which determines an extent to which the respective training data element is taken into account when training the prediction model.

This application claims priority under 35 U.S.C. § 119 to patent application no. DE 10 2024 207 142.0, filed on Jul. 30, 2024 in Germany, the disclosure of which is incorporated herein by reference in its entirety.

### BACKGROUND

The disclosure relates to a computer-implemented method and system for training an artificial intelligence (AI) based prediction model for a given behavior planner that plans the future behavior of an at least partially automated self-driving vehicle based on aggregated scene-specific information. This can be a rule-based behavior planner or an AI-based behavior planner, i.e., a behavior planner that plans the behavior of the self-driving vehicle with the help of a correspondingly trained neural network.

In order to plan safe and comprehensible maneuvers, such a behavior planner must anticipate how the traffic scene in which the automated self-driving vehicle is located will develop. For this purpose, the prediction model predicts at least one future development of the traffic scene, for example in the form of future trajectories of other road users. This information can then be used as a basis for behavior planning for the self-driving vehicle.

Classic prediction methods usually perform a dynamics-based prediction. Since these prediction methods can only model interactions between road users to a limited extent, the use of artificial intelligence or machine learning, in particular deep learning (DL), has established itself as the de facto standard for prediction in recent years.

The disclosure relates to the training of such an AI-based prediction model. The prediction model is to be trained in such a way that it predicts the future development of a traffic scene based on aggregated scene-specific information. At least one training data set with training data elements i generated from scene-specific information from training scenes is used for training. Each training data element i comprises at least one training input [symbol] describing a training scene at a given point in time and a ground truth yᵢ describing the further development of the training scene following the given point in time together with the further behavior of the egov vehicle. The respective type of data used for the training input [symbol] and for the ground truth yᵢ depends on the type of prediction model to be trained. For example, sensor data and/or a scene representation in latent space and/or an environment model can be used to describe the training scene. The further development of the training scene can be described, for example, with the help of trajectory data for the individual participants in the training scene.

Training data elements are usually generated based on scene-specific information or training data that comes from different sources or is obtained in different ways. Examples include (i) Data recorded by a vehicle with a human driver. In this case, the human driver is responsible for the trajectory of the recording vehicle, (ii) Data recorded by an automated vehicle. In this case, the trajectory traveled is determined by the behavior planner of the recording vehicle, (iii) Data recorded by an external observer, such as a drone or infrastructure sensor technology. In this case, each participant in the recorded traffic scene can act as a self-driving vehicle, also known as a pivot vehicle, and (iv) Data generated during a simulation of the temporal development of a training scene. In this case, each participant in the simulated training scene can act as a self-driving vehicle or pivot vehicle.

The use of such training data or training data elements generated from it to train a prediction model for a given behavior planner proves problematic if the driving style or manner of the self-driving vehicle in the training scenes deviates from the intended driving style or manner of the given behavior planner. When predicting the development of a traffic scene, the prediction model assumes a behavior style of the self-driving vehicle as learned from the training scenes, and not the behavior style intended by the downstream behavior planner. As a result, the prediction may not match the planning of the downstream behavior planner.

For example, the behavior planner can be designed for very safe and passive behavior, while agile behavior of the self-driving vehicle and other road users interacting with it was recorded in the training scenes for similar situations. This means that the prediction model encodes the expectation of agile behavior by the self-driving vehicle, so that the predicted maneuvers of other road users assume this agile behavior by the self-driving vehicle, even though this does not correspond to the policy of the behavior planner. This results in a so-called distribution mismatch, i.e., a discrepancy between the behavior style of the self-driving vehicle assumed by the prediction model and the behavior style of the self-driving vehicle intended by the downstream behavior planner. This mismatch can result in the behavior planner being unable to generate any valid planning because, for example, all trajectories planned for the self-driving vehicle collide with trajectories that have been predicted for other road users.

### SUMMARY

The measures according to the disclosure make it possible to train an AI-based prediction model in such a way that it is compatible with a downstream behavior planner, even if the behavior style of the self-driving vehicle in the training scenes deviates from the behavior style implemented by the behavior planner.

According to the disclosure, this is achieved by using the behavior planner to determine a weighting wᵢ for each training data element i, which determines the extent to which the respective training data element i is taken into account when training the prediction model.

By means of weighting wᵢ, training data elements based on training scenes in which the driving style of the self-driving vehicle essentially corresponds to the behavior intended by the behavior planner can be weighted more heavily than training data elements representing training scenes in which the driving style of the self-driving vehicle deviates significantly from the policy of the behavior planner. Through the weighting of the training data elements according to the disclosure, the prediction model learns during training to explicitly take into account the capabilities of the downstream behavior planner. In this way, the discrepancy between the behavior style of the self-driving vehicle assumed by the prediction model and the behavior style of the self-driving vehicle implemented by the downstream behavior planner can be minimized. The weighting of the training data elements according to the disclosure can also be interpreted as a modification of the distribution of the training data, which mitigates the distribution mismatch described above.

In principle, there are different possibilities for determining the weightings wᵢ for the individual training data elements i of a training data set using the given behavior planner in accordance with the disclosure.

Preferably, the behavior planner plans at least one future behavior of the self-driving vehicle based on the training input [symbol] .

In a first variant of the method according to the disclosure, the weightings wᵢ for the individual training data elements i are then determined by determining a planning deviation of the at least one behavior planned for the self-driving vehicle from the further behavior of the self-driving vehicle according to ground truth yᵢ. This at least one planning deviation is then used as the basis for determining the weighting wᵢ of the respective training data element i. If the behavior planner plans several future behaviors of the self-driving vehicle and none of these planned behaviors matches the ground truth yᵢ, then the associated training data element can be heavily weighted or even eliminated from the training data set, while it can remain in the training data set if at least one planned behavior matches the ground truth yᵢ.

If the prediction model is trained such that it predicts a future development of a traffic scene together with the future behavior of the self-driving vehicle on the basis of aggregated scene-specific information, then the weightings wᵢ for the individual training data elements i can also be determined by the prediction model generating at least one training output a( [symbol] ) on the basis of the training input [symbol] in each case. In this case, the training output a( [symbol] ) comprises at least one behavior predicted for the self-driving vehicle. Then, a prediction planning deviation is determined between the at least one behavior predicted for the self-driving vehicle and the at least one behavior planned for the self-driving vehicle. This at least one prediction planning deviation is then used as the basis for determining the weighting wᵢ of the respective training data element i. With the help of the weightings wᵢ determined in this way, the further development of the traffic scene can already be taken into account when training the prediction model of a multimodal prediction.

At this point, it should be expressly noted that the determination of the weightings wᵢ for the individual training data elements i can also be based on a combination of the respective planning deviation and the respective prediction planning deviation.

Both the planning deviations and the prediction-planning deviations can be advantageously determined using a normalized deterministic distance measure, such as a sigmoid function, or using a normalized probabilistic distance measure, such as a normalized likelihood, or using a learned weighting function.

As mentioned at the beginning, the behavior planner should use the predictions of the prediction model to be trained when planning the behavior of the self-driving vehicle. Accordingly, in the context of the disclosure, it proves advantageous if, when training the prediction model, the behavior planner also takes into account the ground truth yᵢ and/or an earlier training output [symbol] of the prediction model as a prediction for the further development of the traffic scene in addition to the training input a( [symbol] ) when planning the future behavior of the self-driving vehicle.

There are not only different possibilities for determining the weightings wᵢ according to the disclosure, but also for how the weightings wᵢ can be used to take the individual training data elements i of a training data set into account to different degrees when training the prediction model.

For example, the weightings wᵢcould be used to eliminate individual training data elements i from the training data set from the outset.

The prediction model is trained iteratively, wherein a training data set is considered in each training step. The prediction model generates at least one training output a( [symbol] ) for each training data element i of the training data set on the basis of the training input [symbol] , which is compared with the ground truth yᵢ. A prediction deviation l(a( [symbol] ), yᵢ) between the at least one training output a( [symbol] ) and the ground truth yᵢ is determined in order to determine a prediction error [symbol] for the training data set. The prediction model is then modified depending on this prediction error [symbol] . This procedure is then repeated with another or even the same training data set until a termination criterion is reached.

In a preferred embodiment of the disclosure, the contributions of the individual training data elements i to the prediction error [symbol] are weighted with the respective weighting wᵢ and in this way taken into account to varying degrees when training the prediction model.

In the simplest case, the prediction error [symbol] is determined as the weighted sum of the deviations l(a( [symbol] ), yᵢ) across all training data elements of the training data set

$$ℒ = \frac{1}{N} {\sum }_{i} {w}_{i} l ( a ( {𝒟}_{i} ) , {y}_{i} )$$

Where N is the number of training data elements i in the training data set. The index i denotes the respective contributions of the individual training data elements i.

At this point, however, it should be expressly noted that other loss functions can also be used in the context of the disclosure to determine the prediction error, as long as the contributions of the individual training data elements are weighted and the weightings are determined with the aid of the behavior planner. The weightings can be taken into account as weighting factors, i.e. multiplicatively, or, for example, as a power.

As already mentioned at the beginning, the given behavior planner can be an AI-based behavior planner. In this case, it is advantageous to train the behavior planner and the prediction model together. Although the method according to the disclosure presupposes a given behavior planner, it can nevertheless also be used in this case by alternately modifying either the prediction model or the behavior planner in each training step. For example, the behavior planner could be taken as given in a training step and a training data set could be used only to modify the weights of the neural network of the prediction model. In the next training step, the same training data set or a different training data set could then be used to modify the behavior planner, while the prediction model is not changed. The weighting of the training data elements according to the disclosure would then only be used in the training steps for the prediction model. This weighting is less effective for training the behavior planner.

### BRIEF DESCRIPTION OF THE DRAWINGS

Exemplary embodiments and advantageous further developments of the disclosure are explained in more detail in the following in conjunction with the figures.

FIG. 1 illustrates a computer-implemented system for training an AI-based prediction model according to the disclosure.

FIGS. 2a and 2b illustrate the problem underlying the disclosure.

FIGS. 3a to 3c illustrate a variant of the training method according to the disclosure.

### DETAILED DESCRIPTION

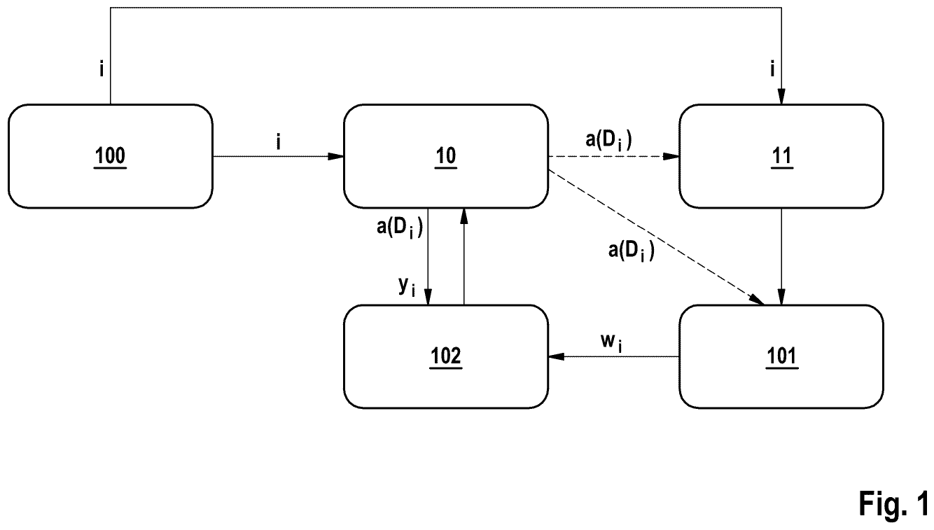

The block diagram in FIG. 1 shows a computer-implemented system for training an AI-based prediction model 10 for a given behavior planner 11, which plans the future behavior of an at least partially automated self-driving vehicle information based on aggregated scene-specific information. The behavior planner 11 can be a rule-based or an AI-based behavior planner.

The system comprises a database 100 that provides training data elements i of at least one training data set for both the prediction model 10 to be trained and the given behavior planner 11. Each training data element i comprises at least one training input [symbol] , which describes a training scene at a predefined point in time, and a ground truth yᵢ, which describes the further development of the training scene following the predefined point in time together with the further behavior of the self-driving vehicle.

The system further comprises a first evaluation module 101 for determining a weighting wᵢ for each training data element i. To do this, the behavior planner 11 plans at least one future behavior for the self-driving vehicle based on the training input [symbol] and provides the result of this planning to the first evaluation module 101.

The weightings wᵢ are made available to a second evaluation module 102 of the system. In the exemplary embodiment described herein, the second evaluation module 102 determines a prediction error [symbol] for the entire training data set. Each training data element i of the training data set contributes to the prediction error [symbol] with a prediction deviation between the training output a( [symbol] ) generated by the prediction model on the basis of the training input [symbol] and the ground truth yᵢ. According to the disclosure, the contributions of the individual training data elements i to the prediction error [symbol] are then weighted with the respective weighting wᵢ. The second evaluation module 102 then modifies the prediction model depending on the prediction error [symbol] .

In a variant of the system shown here, the behavior planner 11 could use an earlier training output a( [symbol] ) of the prediction model 10 in addition to the training input [symbol] in order to plan the future behavior of the self-driving vehicle—indicated here by the dashed arrow between the prediction model 10 and the behavior planner 11.

In a further variant of the system shown here, the first evaluation module 101 could use the training output a( [symbol] ) of the prediction model 10 in addition to the output of the behavior planner 11 in order to determine the weights wᵢ—indicated here by the dashed arrow between the prediction model 10 and the first evaluation module 101.

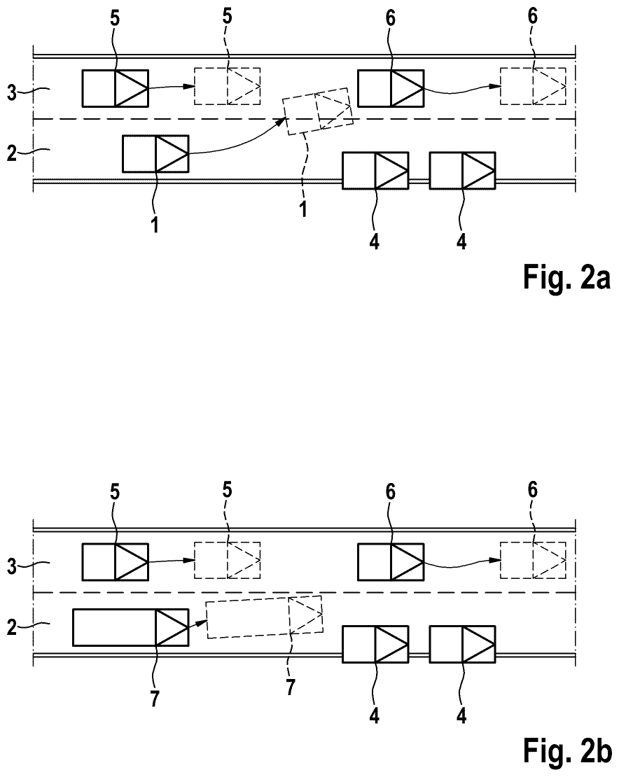

FIG. 2a shows a top view of a training scene recorded by a self-driving vehicle 1. The self-driving vehicle 1 is moving in the right lane 2 of a two-lane road. His onward journey is blocked by parked vehicles 4, so that it is necessary to change lanes to the overtaking lane 3, on which other vehicles 5 and 6 are moving. The self-driving vehicle 1 can switch between the two vehicles 5 and 6 to the fast lane 3.

This training scene will now be used to train an AI-based prediction model for the behavior planner of a delivery robot. Due to its heavier dynamics and slower parameterization, the behavior planner of delivery robot 7 cannot replicate the maneuver of self-driving vehicle 1 in the training scene, as shown in FIG. 2b. Based on the ground truth data from the other vehicles 5 and 6, the planned trajectory of delivery robot 7 deviates significantly from the ground truth trajectory of self-driving vehicle 1 in the training scene, as delivery robot 7 does not change to the passing lane 3 between vehicles 5 and 6. According to the disclosure, the training data element generated on the basis of the training scene shown in FIG. 2a is therefore only weighted very slightly with a weighting wᵢ that approaches zero.

FIG. 2b also illustrates that road users in a traffic scene influence each other and that the behavior of self-driving vehicle 1 in the training scene is therefore implicitly reflected in the recorded behavior of the other road users 5 and 6.

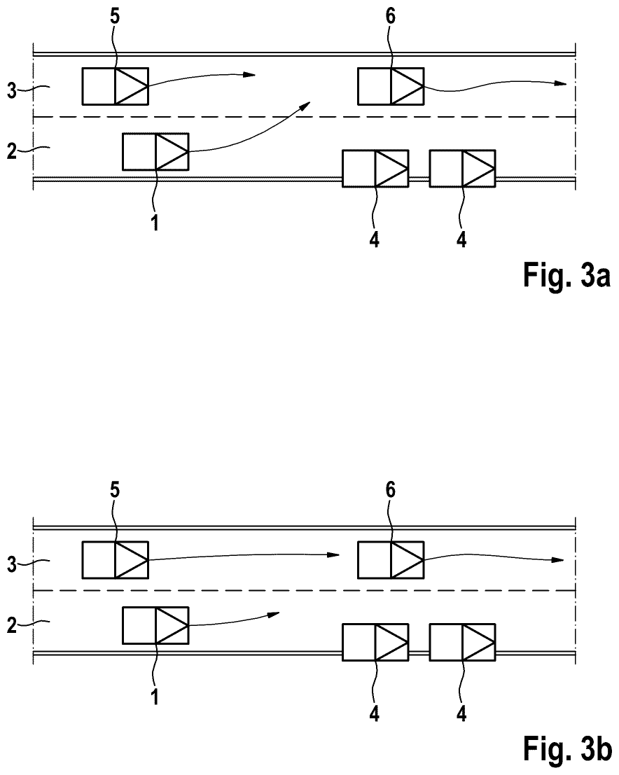

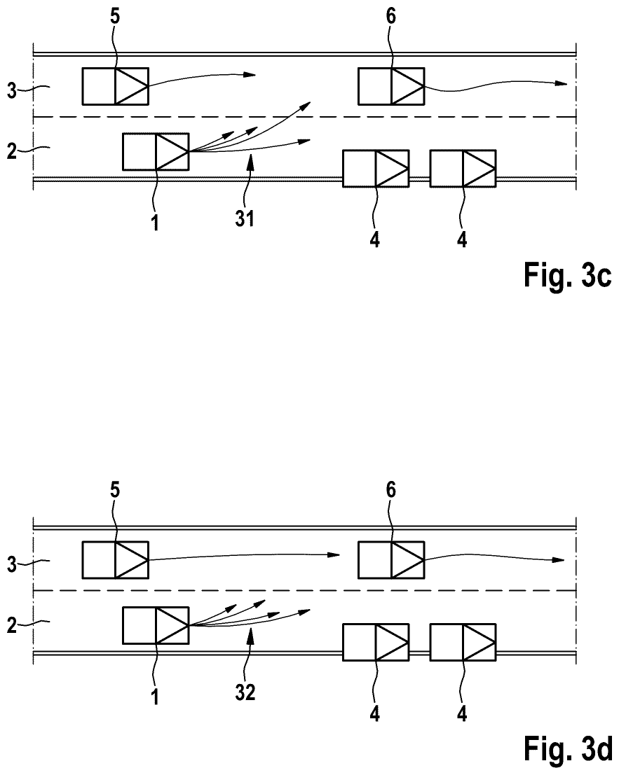

FIGS. 3a to 3d illustrate a variant of the training method according to the disclosure using the training scene shown in FIG. 2a, wherein the prediction model is trained here in such a way that it also predicts the further development of the traffic scene for the self-driving vehicle 1, i.e., not only possible trajectories of the other road users 5 and 6, but also possible trajectories of the self-driving vehicle 1.

FIGS. 3a and 3b illustrate the result of the prediction for the training scene shown in FIG. 2a in the form of two different modes for the future development of this traffic scene.

In the case of FIG. 3a, prediction mode 1, the self-driving vehicle 1 switches between the two vehicles 5 and 6 from the right lane 2 to the passing lane 3.

In the case of FIG. 3b, prediction mode 2, the self-driving vehicle 1 must stop in front of the parked vehicles 4 and wait until both vehicles 5 and 6 have passed, as the gap between the two vehicles 5 and 6 is closing.

FIG. 3c shows three trajectories 31 planned by the behavior planner for prediction mode 1, and FIG. 3d shows three trajectories 32 planned by the behavior planner for prediction mode 2.

Now, a score

$${w}_{i}^{( 1 )} and {w}_{i}^{( 2 )}$$

can be calculated for each of the prediction modes 1 and 2: The score

$${w}_{i}^{( 1 )}$$

for prediction mode 1 is low because the match between the prediction and the planned behavior of the self-driving vehicle is poor. In contrast, the score

$${w}_{i}^{( 2 )}$$

for prediction mode 2 is relatively high because the match between the prediction and the planned behavior of the self-driving vehicle is relatively good.

The weighting wᵢ for the training data element can then be calculated as the mean value of the individual scores, for example:

$${w}_{i} = \frac{1}{M} {\sum }_{j} {w}_{i}^{( j )}$$

Wherein M is the number of prediction modes; in the exemplary embodiment described here, M=2.

What is claimed is:

1. A computer-implemented method for training an artificial intelligence (AI) based prediction model for a given behavior planner that plans a future behavior of an at least partially automated self-driving vehicle based on aggregated scene-specific information, the method comprising:
training the prediction model to predict a future development of a traffic scene based on the aggregated scene-specific information;
using at least one training data set comprising training data elements i for training, which are generated from scene-specific information of a plurality of training scenes, such that each training data element i comprises:
a training input [symbol] that describes a training scene of the plurality of training scenes at a specified point in time, and
a ground truth yᵢ that describes a further development of the training scene following the specified point in time together with a further behavior of the self-driving vehicle; and
determining a weighting wᵢ for each training data element i, which determines an extent to which a respective training data element i is taken into account when training the prediction model.

2. The method according to claim 1, wherein the behavior planner plans at least one future behavior of the self-driving vehicle for determining the weightings wᵢ for individual training data elements i based on a respective training input [symbol] .

3. The method according to claim 2, wherein, in order to determine the weighting wᵢ for the individual training data element i:
a planning deviation of the at least one behavior planned for the self-driving vehicle from the further behavior of the self-driving vehicle according to ground truth yᵢ is determined, and
the planning deviation is used as a basis for determining the weighting wᵢ of the individual training data element i.

4. The method according to claim 2, wherein:
the prediction model is trained to predict the future development of the traffic scene together with the at least one future behavior of the self-driving vehicle based on the aggregated scene-specific information, and
in order to determine the weighting wᵢ for the individual training data element i:
the prediction model generates at least one training output a( [symbol] ) based on the training input [symbol] , wherein the at least one training output a( [symbol] ) comprises at least one behavior predicted for the self-driving vehicle, and
a prediction planning deviation is determined between the at least one behavior predicted for the self-driving vehicle and the at least one behavior planned for the self-driving vehicle, and which is based on at least one prediction planning deviation of the determination of the weighting wᵢ of the training data element i.

5. The method according to claim 1, wherein the weighting wᵢ of the individual training data element i is determined using a normalized deterministic distance measure, a normalized probabilistic distance measure, or a learned weighting function.

6. The method according to claim 4, wherein, when planning the future behavior of the self-driving vehicle, the behavior planner takes into account, in addition to the training input [symbol] , the ground truth yᵢ and/or an earlier training output a( [symbol] ) as a prediction for the further development of the traffic scene.

7. The method according to claim 1, wherein:
the prediction model generates at least one training output a( [symbol] ) for each training data element i based on the training input [symbol] ,
a prediction deviation l(a( [symbol] ), yᵢ) between the at least one training output a( [symbol] ) and the ground truth yᵢ is determined to determine a prediction error [symbol] for the training data set, and
the prediction model is modified depending on the prediction error [symbol] ; and
when determining the prediction error [symbol] , contributions of individual training data elements i are weighted with the respective weighting wᵢ.

8. The method according to claim 7, wherein the prediction error [symbol] is determined as a weighted sum of the deviations l(a( [symbol] ), yᵢ) over all training data elements of the training data set
$$ℒ = \frac{1}{N} {\sum }_{i} {w}_{i} l ( a ( {𝒟}_{i} ) , {y}_{i} ) ,$$
wherein N is a number of training data elements i in the training data set and an index i denotes respective contributions of the individual training data elements i.

9. The method according to claim 1, wherein:
the given behavior planner is an AI-based behavior planner, and
the AI-based behavior planner and the AI-based prediction model are trained together by alternately modifying only either the AI-based prediction model or the AI-based behavior planner in each training step.

10. A computer-implemented system for training an artificial intelligence (AI) based prediction model for a given behavior planner which plans future behavior of an at least partially automated self-driving vehicle based on aggregated scene-specific information, for carrying out the method according to claim 1, the system comprising:
a database configured to provide the training data elements i of the at least one training data set for both the prediction model to be trained and the given behavior planner, wherein each training data element i comprises:
the training input [symbol] that describes the training scene at the specified point in time, and
the ground truth yᵢ that describes the further development of the training scene following the specified point in time, comprising the further behavior of the self-driving vehicle;
a first evaluation module configured to determine the weighting wᵢ for each training data element i, taking into account the at least one behavior planned by the behavior planner based on the training input [symbol] for the self-driving vehicle; and
a second evaluation module configured (i) to determine a prediction error [symbol] for the training data set, for which purpose a prediction deviation between at least one training output a( [symbol] ) generated by the prediction model based on the training input [symbol] and the ground truth yᵢ is determined for each training data element i and contributions of individual training data elements i to the prediction error [symbol] are weighted with the respective weighting wᵢ, and (ii) to modify the prediction model depending on the determined prediction error [symbol] .
